(19) United States
(12) Patent Application Publication
(10) Pub. No.: US 2026/0356052 A1
(43) Pub. Date: Nov. 12, 2026

(54) PULTRUDED AND FILAMENT WOUND COMBINATION UTILITY POLE

(71) Applicant: Thursday Poles, LLC, Fortville, IN (US)

(72) Inventors: William Khamis, Indianapolis, IN (US); Edward Vondell, Key Biscayne, FL (US)

(21) Appl. No.: 19/648,324

(22) Filed: Apr. 15, 2026

Related U.S. Application Data
(60) Provisional application No. 63/789,045, filed on Apr. 15, 2025.

(51) Int. Cl. B29C 70/32; B29C 70/52; B29K 309/08; B29L 31/00

(52) U.S. Cl. CPC B29C 70/32; B29C 70/52; B29K 2309/08; B29L 2031/766

(57) ABSTRACT

The disclosure herein relates generally to combination utility poles and methods of producing combinations utility poles. The methods may include producing a composite utility pole comprising fiberglass and resin material via a pultrusion process, overlaying additional fiberglass and resin material to the composite utility pole, and curing the overlayed additional fiberglass and resin material to form a combination utility pole.

### RELATED APPLICATION

The present application claims the priority benefit of U.S. Patent Application No. 63/789,045, filed Apr. 15, 2025, the entire disclosure of which is incorporated herein by reference.

### BACKGROUND

Fiber reinforced (i.e., composite) utility poles made from a combination of fiber and resin materials can be used as light-weight non-corrosive alternatives to utility poles made of wood, steel, and concrete. For example, wood poles are susceptible to rot, insect damage, and require regular maintenance. Steel poles are prone to corrosion, especially in coastal or industrial environments. Concrete poles, while resistant to corrosion, are heavy and difficult to transport and install.

Composite, or fiberglass reinforced plastic (“FRP”), utility poles, though advantageous in many ways, have several challenges associated with their use. For example, composite utility poles generally have higher initial material costs compared to traditional materials such as wood, steel, or concrete. Composite utility poles also exhibit elastic behavior under environmental forces. Although some elastic behavior is helpful, too much bending can negatively affect the utility pole, including resulting in the utility pole becoming so bent that it is no longer completely in the right of way for the utility company. Work-around solutions, such as filling the composite utility poles with structural foam, bonding fiberglass to the body of the composite utility pole, or nesting poles of increasingly smaller diameters inside each other only create additional issues.

Accordingly, there is a need for a utility pole that provides some flexibility, while maintaining a pole strength that is sufficient to withstand the forces exerted against it.

### SUMMARY

The present disclosure includes disclosure of combination utility poles comprised of a pultruded core with filament winding around the pultruded core. In one example of the present disclosure, a combination utility poles includes a pultruded composite utility pole comprising fiberglass and resin material; and additional fiberglass and resin material overlayed on the composite utility pole according to a predetermined thickness and length, wherein the composite utility pole and the overlayed additional fiberglass and resin material are cured to form a combination utility pole.

In an aspect of an exemplary combination utility pole according to the present disclosure, the combination utility pole includes a thermal material between the composite utility pole and the additional fiberglass and resin material. In an aspect of an exemplary combination utility pole according to the present disclosure, the combination utility pole includes a plurality of standoff supports disposed within the thermal material. In an aspect of an exemplary combination utility pole according to the present disclosure, the combination utility pole includes a protective material between the thermal material and the additional fiberglass and resin material. In an aspect of an exemplary combination utility pole according to the present disclosure, the combination utility pole includes a protective material under the additional fiberglass and resin material. In an aspect of an exemplary combination utility pole according to the present disclosure, the additional fiberglass and resin material is overlayed in a tapered fashion such that the predetermined thickness of the additional fiberglass and resin material gradually changes along a span of the composite utility pole. In an aspect of an exemplary combination utility pole according to the present disclosure, the composite utility pole has a base, and the additional fiberglass and resin material is overlayed in a first stage starting at the base, wherein a first surface of the first stage has a first angle relative to an axis of the composite utility pole, and a second stage adjacent the first stage, wherein a second surface of the second stage has a second angle relative to the axis of the composite utility pole, the second angle being different from the first angle. In an aspect of an exemplary combination utility pole according to the present disclosure, the first angle transitions to the second angle substantially at an intended ground line of the composite utility pole. In an aspect of an exemplary combination utility pole according to the present disclosure, the additional fiberglass and resin material is overlayed via a filament winding process. In an aspect of an exemplary combination utility pole according to the present disclosure, the composite utility pole is cylindrical.

The present disclosure includes disclosure of methods of manufacturing a combination utility pole via a pultrusion process and a filament winding process. In one example of the present disclosure, the method includes producing a composite utility pole comprising fiberglass and resin material via a pultrusion process, and overlaying additional fiberglass and resin material to the composite utility pole, according to a predetermined thickness and length, to form a combination utility pole. The combination utility pole is then cured.

In an aspect of an exemplary method according to the present disclosure, the method includes, before the step of overlaying the additional fiberglass and resin material to the composite utility pole, the step of applying a thermal material to the composite utility pole. In an aspect of an exemplary method according to the present disclosure, the method includes disposing a plurality of standoff supports within the thermal material. In an aspect of an exemplary method according to the present disclosure, the method includes, after the step of applying the thermal material to the composite utility pole, the step of applying a protective material to the thermal material. In an aspect of an exemplary method according to the present disclosure, the method includes, before the step of overlaying the additional fiberglass and resin material to the composite utility pole, the step of applying a protective material such that the protective material is between the additional fiberglass and resin material and the composite utility pole. In an aspect of an exemplary method according to the present disclosure, the additional fiberglass and resin material is overlayed in a tapered fashion such that the predetermined thickness of the additional fiberglass and resin material gradually changes along a span of the composite utility pole. In an aspect of an exemplary method according to the present disclosure, the composite utility pole has a base, and the additional fiberglass and resin material is overlayed in a first stage starting at the base, wherein a first surface of the first stage has a first angle relative to an axis of the composite utility pole, and a second stage adjacent the first stage, wherein a second surface of the second stage has a second angle relative to the axis of the composite utility pole, the second angle being different from the first angle. In an aspect of an exemplary method according to the present disclosure, the first angle transitions to the second angle substantially at an intended ground line of the composite utility pole. In an aspect of an exemplary method according to the present disclosure, the additional fiberglass and resin material is overlayed via a filament winding process. In an aspect of an exemplary method according to the present disclosure, the composite utility pole is cylindrical.

In an aspect of an exemplary combination utility pole according to the present disclosure, the combination utility pole includes a thermal material between the composite utility pole and the additional fiberglass and resin material. In an aspect of an exemplary combination utility pole according to the present disclosure, the combination utility pole includes a plurality of standoff supports disposed within the thermal material. In an aspect of an exemplary combination utility pole according to the present disclosure, the combination utility pole includes a protective material between the thermal material and the additional fiberglass and resin material. In an aspect of an exemplary combination utility pole according to the present disclosure, the combination utility pole includes a protective material under the additional fiberglass and resin material. In an aspect of an exemplary combination utility pole according to the present disclosure, the additional fiberglass and resin material is overlayed in a tapered fashion such that the predetermined thickness of the additional fiberglass and resin material gradually changes along a span of the composite utility pole. In an aspect of an exemplary combination utility pole according to the present disclosure, the composite utility pole has a base, and the additional fiberglass and resin material is overlayed in a first stage starting at the base, wherein a first surface of the first stage has a first angle relative to an axis of the composite utility pole, and a second stage adjacent the first stage, wherein a second surface of the second stage has a second angle relative to the axis of the composite utility pole, the second angle being different from the first angle. In an aspect of an exemplary combination utility pole according to the present disclosure, the first angle transitions to the second angle substantially at an intended ground line of the composite utility pole. In an aspect of an exemplary combination utility pole according to the present disclosure, the additional fiberglass and resin material is overlayed via a filament winding process. In an aspect of an exemplary combination utility pole according to the present disclosure, the composite utility pole is cylindrical.

### BRIEF DESCRIPTION OF THE DRAWINGS

The features and advantages of this disclosure, and the manner of attaining them, will be more apparent and better understood by reference to the following descriptions of the disclosed methods and systems, taken in conjunction with the accompanying drawings, wherein:

FIG. 1 is a side view of a combination utility pole, according to one example of the present disclosure.

FIG. 2 is an illustration of a pultrusion machine and pultrusion process, according to the prior art.

FIG. 3 is an illustration of a filament winding process, according to one example of the present disclosure.

FIG. 4 is an illustration of a filament winding machine, showing an area where additional material is wound on the composite utility pole, according to one example of the present disclosure.

FIG. 5 is a side view of a pultruded utility pole with additional fiberglass and resin material applied in a tapered manner, according to one example of the present disclosure.

FIG. 6 is side view of a thermal protection sleeve applied to a utility pole, according to one example of the present disclosure.

FIG. 7 is cross-section view of a thermal protection sleeve applied to a utility pole, according to one example of the present disclosure.

FIG. 8 is an illustration of a method of producing a combination utility pole, according to one example of the present disclosure.

FIG. 9 is an illustration of a method of producing a combination utility pole, according to one example of the present disclosure.

FIG. 10 is an illustration of a method of producing a combination utility pole having a thermal protection sleeve, according to one example of the present disclosure.

FIG. 11 is an illustration of a composite utility pole according to the prior art.

FIG. 12 is an illustration of a composite utility pole according to the prior art.

FIG. 13 is an illustration of a composite utility pole according to the prior art.

FIG. 14 is an illustration of a combination utility pole, according to one example of the present disclosure.

### DETAILED DESCRIPTION

The descriptions, illustrations, and examples in the present disclosure are given by illustration only and are by no means a limitation. The descriptions, illustrations, and examples are described and discussed in such a way that one skilled in the art may understand and appreciate the principles and practices of the disclosure. Various modifications such as substitutions, additions, and rearrangements, may be made that remain potential applications of the disclosure process.

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosure herein relates generally to a combination utility pole produced using a method comprising a pultrusion and filament winding process. In one example of the present disclosure, the method includes producing a composite utility pole comprising fiberglass and resin material via a pultrusion process, overlaying additional fiberglass and resin material to the composite utility pole according to a predetermined thickness and length via a filament winding process, and curing the combination utility pole comprising overlayed additional fiberglass and resin material. Such a combination utility pole also may be called a putamen utility pole.

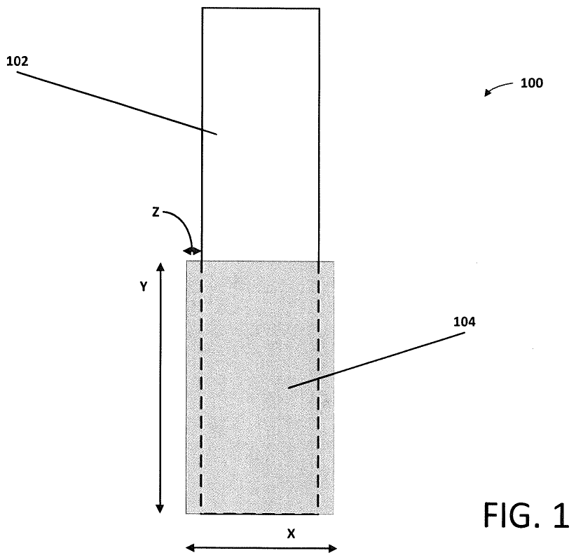

FIG. 1 is an illustration of the combination utility pole 100, according to one example of the present disclosure. The combination utility pole 100 includes a composite utility pole 102 formed via a pultrusion process, and an additional layer of fiberglass and resin material 104 applied around the composite utility pole 102, according to a predetermined length Y and thickness Z. Note that the portion of composite utility pole 102 within fiberglass and resin material 104 is shown with phantom lines in FIG. 1.

In one example of the present disclosure, the layer of fiberglass and resin material 104 is wound and/or bonded to the composite utility pole 102 via a filament winding process, to form a combination utility pole 100. In one example of the present disclosure, the layer of fiberglass and resin material 104 is applied to the composite utility pole 102 for a length Y of approximately 10 feet from the base and a thickness Z of approximately 0.25 inches.

Although the disclosure herein is directed toward the pultrusion and filament winding processes, after becoming familiar with the present disclosure, those of skill in the art will appreciate that other methods can be used to form a combination utility pole 100 (i.e., the disclosure herein should not be interpreted to exclude methods not including pultrusion and filament winding). For example, the combination utility pole 100 can be formed via resin transfer molding process, a hand lay-up process, a spray-up process, a compression molding process, a vacuum-assisted resin transfer process, an autoclave molding process, a roll wrapping process, a blow molding process, and the like. However, for the purposes of this description, the pultrusion process and filament winding process are discussed in further detail below.

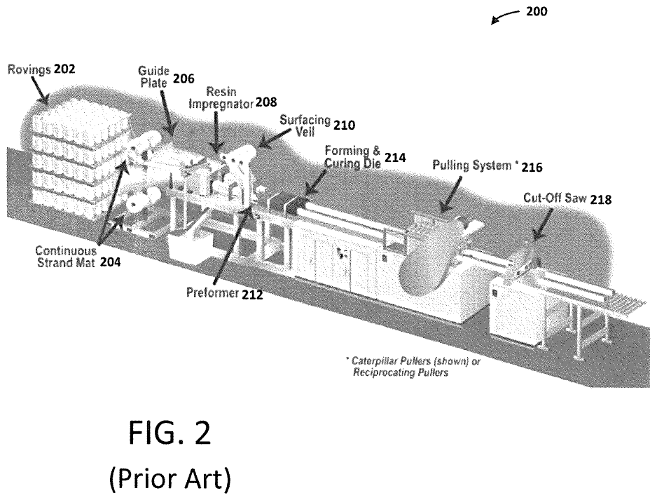

FIG. 2 is an illustration of a pultrusion machine and pultrusion process, according to one prior art example. The pultrusion process typically includes continuously pulling fiberglass and resin through a heated die to quickly cure the resin to produce a composite utility pole typically having a constant diameter and constant wall thickness around a hollow center. As seen in FIG. 2, the pultrusion machine includes rovings 202, a continuous strand mat 204, a guide plate 206, a resin impregnator 208, a surfacing veil 210, a preformer 212, a forming and curing die 214, a pulling system 216, and cut-off saw 218.

Rovings 202 are long strands of fiberglass fibers, which serve as the primary reinforcement material for the composite pole (e.g., the rovings 202 provide strength and stiffness). The rovings 202 are drawn from a spool and guided into the process. The continuous strand mat 204 is used in conjunction with the rovings 202. The continuous strand mat 204 consists of randomly oriented fiberglass strands that are laid out to enhance the structural properties (e.g., provide additional reinforcement in different directions) of the composite. The guide plate 206 directs the rovings 202 and continuous strand mat 204 into the resin impregnation system. It ensures that the materials are aligned properly as they enter the resin impregnator 208, maintaining the correct orientation for consistent material flow.

The resin impregnator 208 saturates the fiberglass material with resin material, ensuring the fibers making up the fiberglass material are thoroughly coated. In one example, the resin is a thermoset polymer, which cures during a curing process to bind the fiberglass fibers together to form the composite material. The surfacing veil 210 consists of a thin layer of resin-impregnated fiber or mat. The surfacing veil 210 can be applied over the composite material to improve the appearance and protect the outer layers from environmental factors such as UV radiation and moisture.

The preformer 212 shapes the fiberglass and resin material (and optionally the surfacing veil 210) as it moves through the pultrusion machine. In one example, the preformer 212 includes a set of rollers or guides that compact and align the fiberglass fibers and resin material (and optionally the surfacing veil 210) as the material passes through the preformer 212. The forming and curing die 214 heats the fiberglass and resin material to initiate the curing process. In one example, the forming die shapes the fiberglass and resin material into a cylindrical utility pole shape, while the curing die applies heat to harden and solidify the fiberglass and resin material to form a chemical bond in the composite material structure.

The pulling system 216 continuously pulls the composite material through the die at a consistent speed ensuring that the material moves through the pultrusion machine at a predetermined rate thereby ensuring that the resin cures properly without over-heating or under-curing. Caterpillar pullers are shown in FIG. 2, but reciprocating pullers also may be employed. The cut-off saw 218 cuts the composite utility pole to a predetermined length.

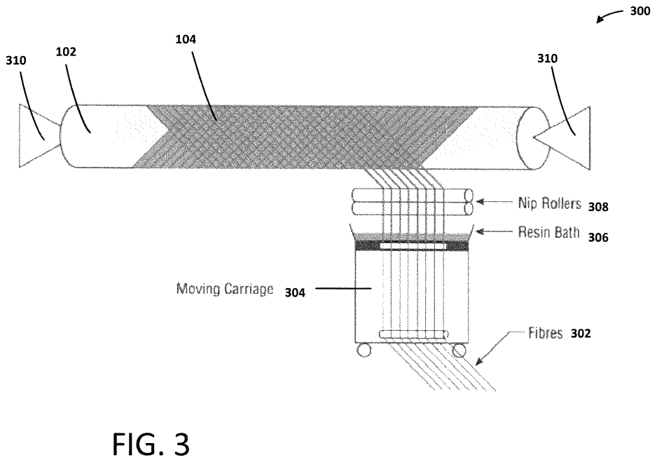

FIG. 3 is an illustration of a filament winding process 300, according to one example of the present disclosure. As seen in FIG. 3, a fiberglass and resin material 104 is wrapped around the composite utility pole 102. Prior to wrapping the fiberglass and resin material 104 around the composite utility pole 102, fiberglass 302 is disposed in a resin bath 306 to apply a resin material to the fiberglass 302, creating the fiberglass and resin material 104. The fiberglass and resin material 104 then is wrapped around the composite utility pole 102. In one example, the filament winding process 300 includes disposing the fiberglass material 302 over a moving carriage 304 prior to disposing the fiberglass material 302 in the resin bath 306. After the fiberglass material 302 is disposed in the resin bath 306, the fiberglass material having a resin applied thereon is disposed over one or more nip roller(s) 308. The fiberglass and resin material 104 is then applied to composite utility pole 102 via a rotating mandrel 310.

In one example, the filament winding process 300 involves the use of resin-impregnated fiberglass strands, which are wound onto a rotating mandrel. The mandrel serves as the shaping tool for the pole, dictating its overall dimensions and geometry. The length of the finished pole is determined by two primary factors: the length of the mandrel and the extent of the mandrel over which the fiberglass is placed. By adjusting the placement and distribution of the fiberglass strands along the mandrel, manufacturers can produce poles of varying lengths to meet specific design requirements.

In one example, the filament-wound combination utility pole 100 includes a tapered design, constructed as single or multi-sectional units. The wall thickness Z of a filament-wound pole is determined by the number of fiberglass windings applied during the manufacturing process. This thickness Z is controlled by the layering of the resin-impregnated strands, with each additional layer contributing to the structural integrity and mechanical properties of the pole.

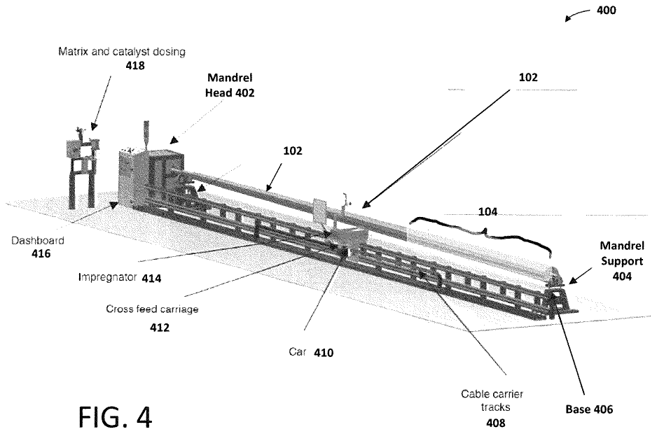

FIG. 4 is an illustration of a filament winding machine 400, having an area where additional fiberglass and resin material 104 is wound on the composite utility pole 102, according to one example of the present disclosure. The additional fiberglass and resin material 104 is applied to the composite utility pole 102 positioned with the filament winding machine. As seen in FIG. 4, filament winding machine 400 may comprise the following components: mandrel head 402, mandrel support 404, base 406, cable carrier tracks 408, car 410, cross feed carriage 412, impregnator 414, dashboard 416, and matrix and catalyst dosing control 418, although other configurations are possible.

The fiberglass and resin material 104 is applied to a predetermined area (e.g., length) of the composite utility pole. In one example of the present disclosure, the length Y of fiberglass and resin material 104 is approximately 10 feet from the base of the composite utility pole 102, but other lengths such as but not limited to 8.5 feet, 9 feet, 9.5 feet, 10 feet, 10.5 feet, 11 feet, and 11.5 feet may be employed. In one example of the present disclosure, the fiberglass and resin material 104 is applied to a thickness Z of approximately 0.25 inches, but other thicknesses such as but not limited to 0.125 inches, 0.143 inches, 0.167 inches, 0.20 inches 0.25 inches, 0.33 inches, and 0.50 inches may be employed. The fiberglass and resin material 104 physically adheres and/or chemically bonds to the composite utility pole 102.

Adding fiberglass and resin material 104 to increase the overall wall thickness Z of the composite utility pole 102 increases the composite utility pole's bending strength. By chemically bonding the fiberglass and resin material 104 to the composite utility pole 102, the process forms a combination pole 100 that is structurally superior to any composite utility pole created solely via the pultruding process.

For example, as shown in Table 1 below, utility poles are ranked in classes based on their breaking load.

TABLE 1
Pole Strength Classification

| | Breaking Load |
|---|---|
| Pole Class | (lbs.) |
| H3 | 7,500 |
| H2 | 6,400 |
| H1 | 5,400 |
| 1 | 4,500 |
| 2 | 3,700 |
| 3 | 3,000 |
| 5 | 2,400 |

Adding fiberglass and resin material can significantly increase the pole strength classification of a composite utility pole. For example, adding approximately 0.25 inches of fiberglass and resin material from the base of the composite utility pole to a predetermined height of approximately 10 feet to a composite utility pole having a height of 40 feet from the base and 0.50 inch wall thickness can increase the pole class rating from class 1 to H1.

Moreover, the additional weight of the fiberglass and resin material is significantly less than using a thicker-walled composite utility pole to accomplish the increased pole class rating (e.g., composite utility pole with 0.75 inch thick walls). For example, adding 0.25 inch thick fiberglass and resin material to the lower 10 feet of the composite utility would increase the weight of the composite utility pole by only about 100 lbs. By comparison, increasing the wall thickness from 0.50 inch to 0.75 inch for the entire 40 foot length of the composite utility pole increases the weight of the composite utility pole by 300 lbs.

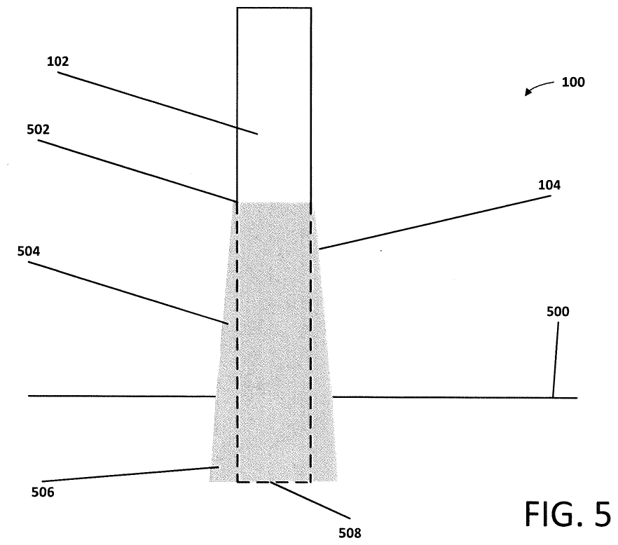

FIG. 5 is an illustration of a pultruded composite utility pole 102 with additional fiberglass and resin material 104 applied in a tapered manner. As used throughout the description herein, the terms “tapered,” and “tapered manner” refer to a gradient of fiberglass and resin material 104 applied to a predetermined length of the composite utility pole 102. The gradient being formed by a shrinking diameter of fiberglass and resin material 104 along the composite utility pole 102. In one example of the present disclosure, the fiberglass and resin material 104 is applied using a filament winding process. For the purposes of the discussion, the term “filament winding process” should be interpreted as an example of a method of applying fiberglass and resin material 104 to a pultruded utility pole 102 to form a combination utility pole 100. Filament winding process should not be interpreted to limit the scope of the disclosure to a singular method of adding fiberglass and resin material 104 to a pultruded utility pole 102.

As seen in FIG. 5, a tapered portion 504 of additional fiberglass and resin material 104, applied via a filament winding process, begins at a ground line 500 where the combination utility pole 100 emerges from the ground. The additional fiberglass and resin material 104 tapers away from the ground line 500 and the terminates at a predetermined end point.

As seen further in FIG. 5, the combination utility pole 100 can also include an untapered or a less-tapered filament wound portion 506 of fiberglass and resin material 104 that starts at the base of the pole 508 and terminates at the ground line 500. The term “partially tapered” is defined as a tapered portion that has a lesser gradient (e.g., lesser shrinking diameter) of fiberglass and resin material 104 applied across the applicable portion of composite pole 102. Note that the portion of composite utility pole 102 within fiberglass and resin material 104 is shown with phantom lines in FIG. 5.

The addition of tapered fiberglass and resin material 104 to the base improves the combination utility pole 100's ability to carry groundline stresses. The fiberglass and resin material 104 also allows the combination utility pole 100 to carry additional stresses at the transition point 502 (i.e., position on the combination utility pole 100 where fiberglass and resin material 104 ends). Applying the fiberglass and resin material 104 along a tapered gradient on the combination utility pole 100 more evenly distributes stresses along the fiberglass and resin material 104.

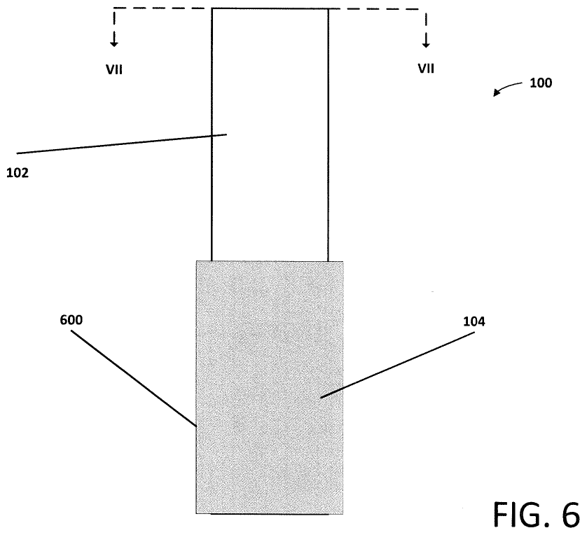

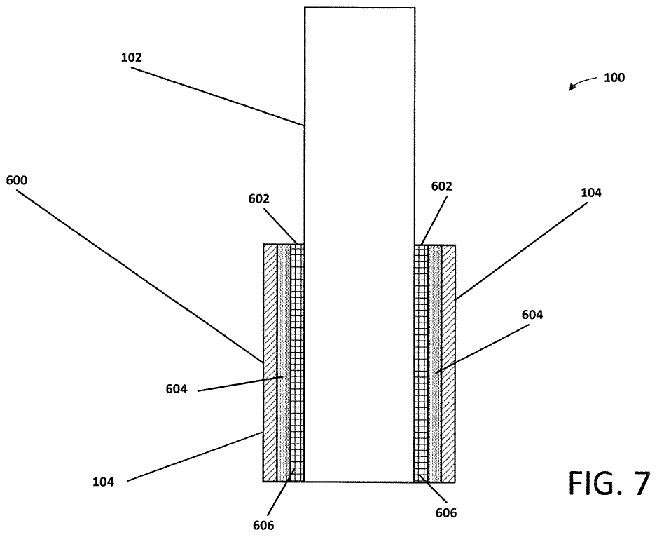

FIG. 6 is a side view of a thermal protection sleeve applied to a combination utility pole 100, according to one example of the present disclosure. FIG. 7 is a cross-section of combination utility pole 100 of FIG. 6, taken on line VII-VII. Shown in FIGS. 6-7 are composite utility pole 102, around which thermal protection sleeve 600 is deployed. In one example of the present disclosure, thermal protection sleeve 600 comprises layers of thermal material 602 and fiberglass and resin material 104. In one example of the present disclosure, thermal protection sleeve 600 comprises layers of thermal material 602, protective material 604, and fiberglass and resin material 104.

When a composite (or FRP) utility pole is disposed in the ground and outfitted with transformers and/or conductors, high horizontal loads are placed on the pole. Particularly in certain wildfire situations, heat from a fire combined with the horizontal load can cause the composite utility pole to bend. The temperature from fire heats the wall of the utility pole. If the wall temperature rises above the glass transition temperature (approximately 400 degrees F) the resin softens, leading to reduced stiffness and mechanical performance. The inherent loads from the conductor lines, transformers, or other equipment on the pole can bend the pole during a wildfire. Wind loads can also bend the poles during a wildfire if wall temps exceed the glass transition temperature. In some situations, the composite poles are permanently bent and as a result lose a significant amount of strength. To protect the composite utility poles from the effects of the heat associated with wildfires, a thermal protection sleeve can be applied to a predetermined portion of the composite utility poles (e.g., a portion of the composite utility pole most likely exposed to the effects of wildfire heat).

In one example of the present disclosure, the thermal protection sleeve 600 includes a layer comprising a thermal material 602 covered by a shell of fiberglass and resin material 104 formed via a filament winding process. The thermal material 602 can be any material that significantly reduces the heat flux from the flames of a wildfire. Examples of such materials include an intumescent coating, refractory materials, furnace wool, ceramic fiber cloth, silicone carbine, basalt, etc. In one example of the present disclosure, the thermal material is applied completely around the circumference of composite utility pole 102.

In another example of the present disclosure, the thermal protection sleeve 600 includes an inner layer comprising a thermal material 602 and middle layer comprising a protective material 604 that prevents the thermal layer 602 from compressing when the shell of fiberglass and resin material 104 is applied. In this example, the inner layer of thermal material 602 and middle layer of protective material 604 are both covered by the shell of fiberglass and resin material 104. The protective material 604 can be any fire-resistant material that provides rigidity and/or support to the thermal material 602. Examples of such materials can include metals, thermal plastics, or any other rigid materials.

In one example of the present disclosure, a plurality of standoff supports 606 (e.g., spacers) are disposed within the thermal material 602 to resist compression of the thermal material 602 when the shell of fiberglass and resin material 104 is applied. In another example of the present disclosure, the plurality of standoff supports 606 are disposed within the thermal material 602 and between the protective material 604. The plurality of standoff supports 606 may create separation between surfaces of the thermal material 602 and the protective material 604, further limiting conductive heat transfer and thermal damage. The standoff supports 606 can comprise any materials having a low thermal conductivity.

Moreover, the standoff supports 606 are not limited to specific configuration or orientation (i.e., the standoff supports 606 can be arranged depending on the specific thermal management requirements). For example, the standoff supports 606 can be organized in any manner throughout the thermal material 602 so long as their configuration reduces conductive heat transfer between the protective material 604 and the thermal material 602, and/or improves the compressive strength of the thermal material 602.

In one example of the present disclosure, the thermal protection sleeve further includes the aforementioned shell comprising a fiberglass and resin material 104 applied via a filament winding process. Examples of fiberglass and resin material 104s include any of the fiberglass and resin material 104s described herein (e.g., fiberglass, etc.). In one example of the present disclosure, the fiberglass and resin material 104 includes a material with a thermoset matrix wound continuously around the thermal protection sleeve.

The thermal protection sleeve 600 can be applied to approximately 10 feet of a composite utility pole 102 when measured from the ground line along the body of the composite utility pole 102. Although one example of the present disclosure includes a thermal protection sleeve 600 of approximately 10 feet in length, the thermal protection sleeve 600 can include any length necessary to provide fire resistance to the utility pole. For example, the thermal protection sleeve can include a length of 8 feet, 8.5 feet, 9 feet, 9.5 feet, 10 feet, 10.5 feet, 11 feet, 11.5 feet, 12 feet, etc., when measured from the ground line.

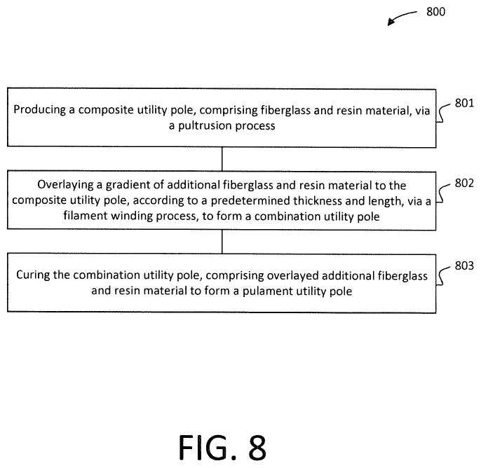

FIG. 8 is an illustration of a method of producing a combination utility pole, according to one example of the present disclosure. In one example, the method 800 of producing a combination utility pole includes the steps of: producing a composite utility pole, comprising fiberglass and resin material via a pultrusion process (i.e., activity 801); overlaying a gradient of additional fiberglass and resin material to the composite utility pole, according to a predetermined length Y and thickness Z, via a filament winding process, to form a combination utility pole (i.e., activity 802); and curing the combination utility pole comprising overlayed additional fiberglass and resin material (i.e., activity 803). During curing, the resin forms a network of chemical bonds or crosslinking which solidifies the resin and strengthens the composite thereby increasing the force binding the additional fiberglass to the composite utility pole and reducing weak points. The process of curing is not limited to an oven such as a kiln, and can include a process comprising heat, pressure, and/or ultraviolet light.

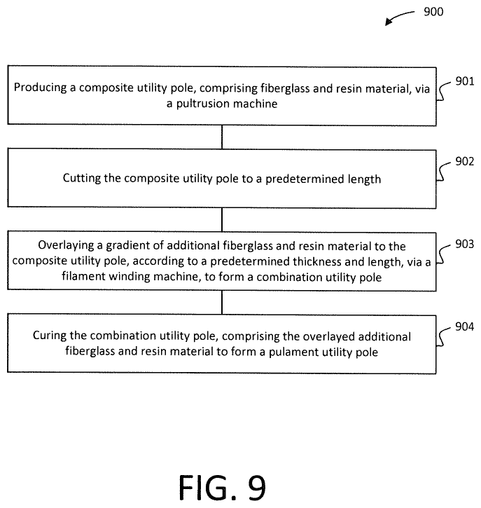

FIG. 9 is an illustration of a method of producing a composite utility pole, according to one example of the present disclosure. In one example, the method 900 includes: producing a composite utility pole, comprising fiberglass and resin material, via a pultrusion machine (i.e., activity 901); cutting the composite utility pole to a predetermined length (i.e., activity 902); overlaying a gradient of additional fiberglass and resin material (i.e., filament materials) onto to the composite utility pole, according to a predetermined length Y and thickness Z, via a filament winding process, to form a combination utility pole (i.e., activity 903); and curing the combination utility pole comprising the overlayed additional fiberglass and resin material (i.e., 904).

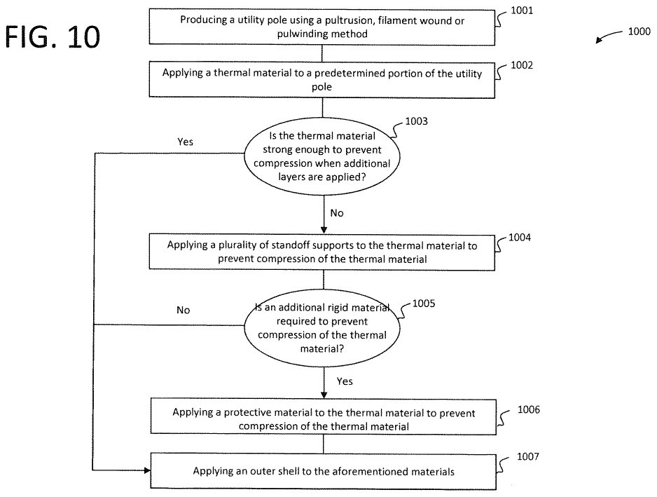

FIG. 10 is an illustration of a method of producing a combination utility pole having a thermal protection sleeve, according to one example of the present disclosure. In one example, the method 1000 includes producing a composite utility pole (i.e., activity 1001), and applying a thermal material to a predetermined portion of the utility pole (i.e., activity 1002).

If the thermal material is not strong enough to prevent compression when additional layers are provided, applying a plurality of standoff supports to the thermal material to prevent compression of the thermal material (i.e., activity 1004). If the thermal material is strong enough to prevent compression when additional layers are provided, applying an outer shell to the thermal material (i.e., activity 1007).

If the plurality of standoff supports are applied to the thermal material (i.e., activity 1004) and an additional rigid material is required to prevent compression of the thermal material, the method 1000 further includes applying a protective material onto the thermal material and standoff supports (i.e., activity 1006). If an additional rigid material is not required, the method 1000 includes applying an outer shell to the thermal material (i.e., activity 1007).

If the protective material is applied to the thermal material and standoff supports (i.e., activity 1006), the method 1000 further includes applying an outer shell to the protective material and standoff supports (i.e., activity 1007).

In one example of the present disclosure, the combination utility pole, comprising a pultruded pole with additional layers of filament wound materials, has a tapered shape wherein a first end (e.g., a base) of the combination utility pole has a wider diameter than a second end (e.g., a top) of the combination utility pole. The tapered shape may have a consistent gradient, or alternatively, may have a partially tapered portion having a lesser gradient, and a fully tapered portion having a larger gradient, with the partially tapered portion terminating at a predetermined position on the pole to make way for the fully tapered portion over any remaining portion of the combination utility pole that may need additional filament wound materials. For example, the combination utility pole may be partially tapered from the base below ground to the ground line, and then from the ground line to the top, the combination utility pole may be fully tapered. For the purposes of the disclosure herein the distances and lengths described throughout this disclosure should not be interpreted to being limited to specific starting and ending points (e.g., the fully tapered portion can terminate at a position on the utility pole that is not the end).

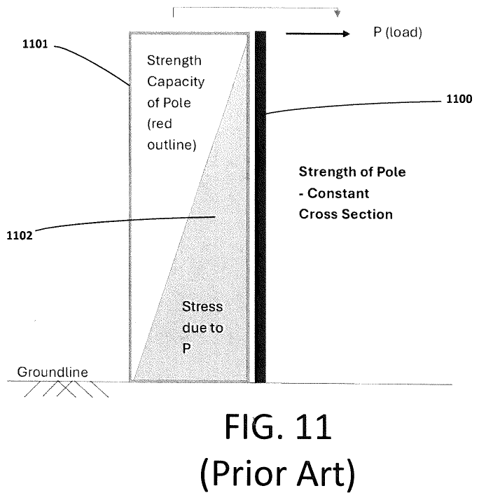

FIG. 11 is an illustration of a composite utility pole 1100 according to the prior art. In this case, the composite utility pole is a pultruded pole with a constant cross-section. A constant cross section pole needs to be designed for the maximum moment or stress due to the load, P, near the top of the pole. The maximum stress is at the ground line. Thus, the strength capacity of pole 1101 needs to be designed to carry the groundline stress. Since the pole has a constant cross section, the strength capacity 1101 remains the same along the height of the pole (outline). However, the applied stress 1102 linearly decreases with height until it is zero at the top (the shaded area). Therefore, there is a significant excess of strength capacity of the pole in this design.

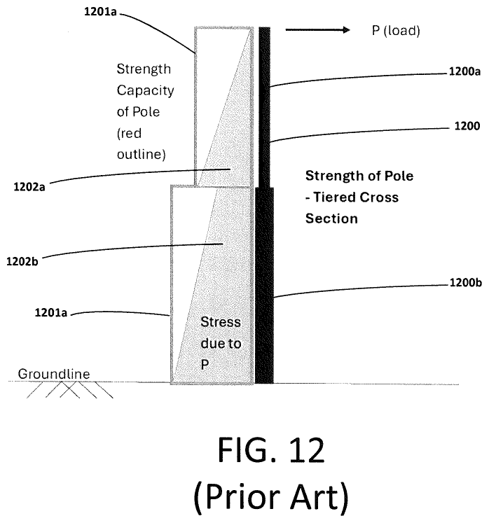

FIG. 12 is an illustration of a composite utility pole 1200 according to the prior art. In this case, composite utility pole 1200 is tiered cross section pole comprising upper section 1200a and base section 1200b. Composite utility pole 1200 is shown with only two sections for ease of illustration. A tiered cross section composite pole may have more than two sections. A tiered cross section pole design reduces the excess strength capacity of a pole design. The base section 1200b has a cross section which is designed to carry the maximum stress at groundline. Since the applied stress 1202a, 1202b on the pole decreases with height (shaded area), reductions in the cross sectional area of the pole reduces the unused strength capacity 1201a, 1201b (outline). At the interface locations where the sections change, there will be an increase in stress at the transition from the larger section to smaller section. The moment at the interface is the same, however, the smaller section has smaller section properties which will cause it to see a higher stress.

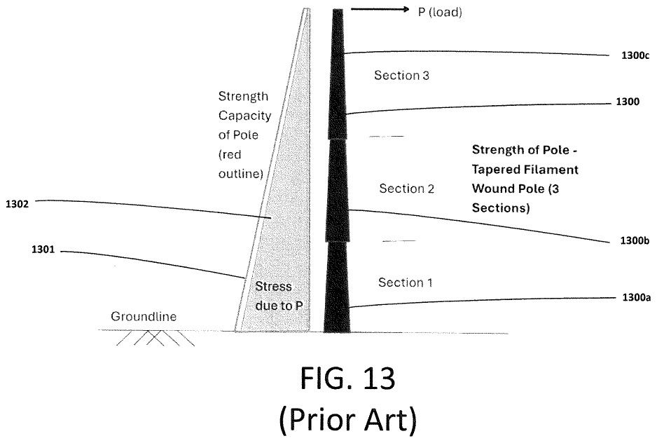

FIG. 13 is an illustration of a tapered sectional filament wound pole 1300 according to the prior art. In this case, tapered sectional filament wound pole 1300 is tiered cross section pole comprising base section 1300a, middle section 1300b, and upper section 1300c. Tapered sectional filament wound pole 1300 is shown with only three sections for ease of illustration. A tiered cross section composite pole may have more than three sections. A tapered sectional filament wound pole can be designed to match the strength requirements of the pole with minimal unused strength. However, since a tapered sectional filament wound poles are fabricated by filament winding over mandrels, a tapered sectional filament wound poles are typically multi-sectional poles as mandrels of significant length and size are very costly and difficult to handle. The mandrels are typically 10 feet to 30 feet in length, which necessitates the combining of several sections to make the tapered sectional filament wound pole. The connections between the sections are typically made in either of the following ways: 1) a slip fit with a through bolt to secure the connection or 2) a friction fit where the sections need to be jacked together and then secured by a through bolt. Significant labor, time and costs are required to assemble the sections into the tapered sectional filament wound pole. Referring to FIG. 13, the shaded area 1302 shows the stress levels of the pole due to the applied load P. The area under the outline 1301 represents the strength capacity of the pole. For the pole to carry its design loads the strength capacity needs to exceed the stress levels of the pole at all locations.

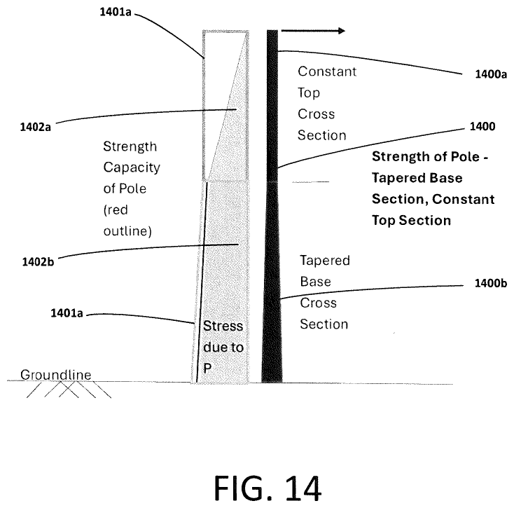

FIG. 14 is an illustration of a combination utility pole 1400, according to one example of the present disclosure. The tapered base/constant top cross section hybrid pole such as combination utility pole 1400 is a cost and strength capacity optimized design. The tapered bottom section 1400b of pole 1400, where the loads are the highest, is designed to carry the design loads 1402b of the pole 1400 minimizing any unused capacity 1401a. The constant section pultruded top section 1400a of the pole 1400 is more cost effective while minimizing the overall unused capacity of the pole. Referring to FIG. 14, the shaded areas 1402a, 1402b show the stress levels of the pole due to the applied load P; the areas under the outlines 1401a, 1401b represent the strength capacity of the pole 1400. For the pole to carry its design loads the strength capacity needs to always exceed the stress levels of the pole at all locations. For the tapered portion of the pole, the taper can be designed to closely match and carry the anticipated stress on the pole. At an engineered location, the pole transitions to a constant cross section. The transition can be designed to minimize any significant increase in stress.

While this disclosure has been described as having preferred designs, the apparatus and methods according to the present disclosure can be further modified within the scope and spirit of this disclosure. This application is therefore intended to cover any variations, uses, or adaptations of the disclosure using its general principles. For example, any methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

What is claimed is:

1. A method of producing a combination utility pole, the method comprising the steps of:
producing a composite utility pole comprising fiberglass and resin material via a pultrusion process;
overlaying additional fiberglass and resin material to said composite utility pole, according to a predetermined thickness and length; and
curing said composite utility pole and said overlayed additional fiberglass and resin material to form a combination utility pole.

2. The method of claim 1, further comprising, before the step of overlaying said additional fiberglass and resin material to said composite utility pole, the step of:
applying a thermal material to said composite utility pole.

3. The method of claim 2, further comprising the step of:
disposing a plurality of standoff supports within said thermal material.

4. The method of claim 2, further comprising, after the step of applying said thermal material to said composite utility pole, the step of:
applying a protective material to said thermal material.

5. The method of claim 1, further comprising, before the step of overlaying said additional fiberglass and resin material to said composite utility pole, the step of:
applying a protective material such that said protective material is between said additional fiberglass and resin material and said composite utility pole.

6. The method of claim 1, wherein said additional fiberglass and resin material is overlayed in a tapered fashion such that said predetermined thickness of said additional fiberglass and resin material gradually changes along a span of said composite utility pole.

7. The method of claim 1, wherein said composite utility pole has a base, and wherein said additional fiberglass and resin material is overlayed in a first stage starting at said base, wherein a first surface of said first stage has a first angle relative to an axis of said composite utility pole, and a second stage adjacent said first stage, wherein a second surface of said second stage has a second angle relative to said axis of said composite utility pole, said second angle being different from said first angle.

8. The method of claim 7, wherein said first angle transitions to said second angle substantially at an intended ground line of said composite utility pole.

9. The method of claim 1, wherein said additional fiberglass and resin material is overlayed via a filament winding process.

10. The method of claim 1, wherein said composite utility pole is cylindrical.

11. A combination utility pole comprising:
a pultruded composite utility pole comprising fiberglass and resin material; and
additional fiberglass and resin material overlayed on said composite utility pole according to a predetermined thickness and length,
wherein said composite utility pole and said overlayed additional fiberglass and resin material are cured to form a combination utility pole.

12. The combination utility pole of claim 11, further comprising:
a thermal material between said composite utility pole and said additional fiberglass and resin material.

13. The combination utility pole of claim 12, further comprising:
a plurality of standoff supports disposed within said thermal material.

14. The combination utility pole of claim 12, further comprising:
a protective material between said thermal material and said additional fiberglass and resin material.

15. The combination utility pole of claim 11, further comprising:
a protective material under said additional fiberglass and resin material.

16. The combination utility pole of claim 11, wherein said additional fiberglass and resin material is overlayed in a tapered fashion such that said predetermined thickness of said additional fiberglass and resin material gradually changes along a span of said composite utility pole.

17. The combination utility pole of claim 11, wherein said composite utility pole has a base, and wherein said additional fiberglass and resin material is overlayed in a first stage starting at said base, wherein a first surface of said first stage has a first angle relative to an axis of said composite utility pole, and a second stage adjacent said first stage, wherein a second surface of said second stage has a second angle relative to said axis of said composite utility pole, said second angle being different from said first angle.

18. The combination utility pole of claim 17, wherein said first angle transitions to said second angle substantially at an intended ground line of said composite utility pole.

19. The combination utility pole of claim 11, wherein said additional fiberglass and resin material is overlayed via a filament winding process.

20. The combination utility pole of claim 11, wherein said composite utility pole is cylindrical.
